(19) United States
(12) Patent Application Publication
(10) Pub. No.: US 2013/0134201 A1
(43) Pub. Date: May 30, 2013

(54) GUIDE FOR GUIDING THE CUTTING OF A PIECE OF PLASTERBOARD, AND KIT AND METHOD FOR THE IMPLEMENTATION THEREOF

(71) Applicant: Benoit Mallet, Evreux (FR)

(72) Inventor: Benoit Mallet, Evreux (FR)

(21) Appl. No.: 13/642,370

(22) PCT Filed: Apr. 18, 2011
(86) PCT No.: PCT/IB2011/051675

§ 371 Date: Feb. 8, 2013

(30) Foreign Application Priority Data
Apr. 21, 2010 (FR) 1001702

(51) Int. Cl. B28D 1/22; B26B 29/06; B26D 3/08

(52) U.S. Cl. CPC B28D 1/225; B26D 3/085; B26B 29/06
USPC 225/2; 83/745; 83/880

(57) ABSTRACT

The aim of the invention is to provide a solution for guiding the cutting of a piece of plasterboard, which can be rapidly implemented, and does not require any finishing step for refilling the surface of the piece of plasterboard. To this end, the invention relates to a guide element (200) for guiding the cutting of a piece of plasterboard, said guiding element having two longitudinal edges and two ends, for guiding a cutting blade, during operation, parallel to the guiding element, said guiding element also comprising, at least on one end, a rotatably mounted abutment (210) provided with means (211) for holding the abutment against the piece of plasterboard.

The invention relates to a guide for cutting a plasterboard, to a kit and to a method of implementation.

A plasterboard is a board made from a layer of plaster covered, on at least one face, with a sheet of cardboard or of paper. In general, both faces of the board are covered with a sheet of cardboard or of paper.

Plasterboards are generally fabricated at a factory, and are used to make partition walls, ceilings and to line rough walls, etc. These boards therefore replace the use of powdered plaster diluted in water for coating walls, which is a tiring and lengthy operation and requires a great deal of skill in order to obtain an optimum plaster composition and satisfactory flatness of the coated surface.

These boards have the advantage of being easy to handle and of allowing work to progress rapidly. Further, the skill required for positioning them is lower by comparison with traditional plasterwork. Finally, in-factory fabrication makes it possible to obtain plasters of optimum composition. However, for cost and stock-control reasons, factory fabrication involves creating boards of standard sizes.

Although there are various standard dimensions, both in terms of length and width and in terms of thickness, it is often necessary to cut these boards to tailor them to the widths and lengths of the walls or ceiling of the room that is to be fitted therewith.

This cutting, which is performed on site to the appropriate dimensions, needs to be quick and as clean as possible in order to allow two boards to be positioned contiguously with ease.

Conventionally, this cutting involves “marking” the board using a cutter blade to cut the first sheet of cardboard and score the layer of plaster. Next, the operator applies stress to the board in such a way that the layer of plaster snaps into two pieces along the scored line. Finally, the operator cuts through the second sheet of cardboard using his cutter in order to separate the two pieces of board.

Finally, a finishing operation has to be performed to fill the gap between two contiguous plasterboards, using a filler product such as plaster or a ready-mix. Once applied, this filler product is smoothed using a plastering knife.

The finishing step has to be as quick as possible. For that, it is necessary to limit the number of actions that the user has to perform. Cleanly cut boards would make it possible not only to limit the amount of filler product used, but also the number of actions that have to be performed in order to smooth the surface on and around the gap.

There are various solutions for creating a cutting guide.

The simplest is to use a rule, preferably a metal rule, and to hold it in position while scoring the board using the cutter.

However, sometimes the rule cannot be held firmly enough to counter the force applied against the rule by the scoring movement of the cutter.

This solution is hazardous to the operator because the cutter may slip and injure the user. Further, these slippages lead to a scored line that is not straight, which means that the cut obtained is uneven: the longitudinal cut is not straight and the cut edge face thus obtained has numerous protrusions.

One solution is to fit the guide with retaining means that hold it on the plasterboard. In general, these retaining means adopt the form of a clamp that firmly fixes the guide to the board.

This approach has two major drawbacks. The first is that the retention is dependent on the firmness of the clamping which means that, in order to achieve effective retention, it is necessary for the clamps to be clamped tightly onto the board. As the board is made of a relatively friable material, there is no avoiding the fact that the surface faces of the board will become marked and damaged by this clamping. It then becomes necessary, during the finishing operations, to make good these marks by filling them with filler. Now, the layout and size of the clamps generally used to hold the guide effectively in place lead to marks being made in regions that are particularly extensive and remote from the cut edge face subsequently obtained. The finishing operation therefore has to involve a specific step of filling these marks, independent of the filling of the space between two consecutive boards.

The second drawback lies in the time it takes to position the guide. Thus, the guide has first of all to be positioned along the previously marked-out cutting line, then the clamps have to be tightened. This tightening often leads to small changes in position which entail loosening the clamps and repositioning the guide. This system is therefore lengthy to implement, somewhat impractical, and carries the risk of damaging the surface faces of the plasterboard.

This is why such systems are only very rarely used in practice.

It is therefore an objective of the present invention to propose a cutting guidance solution that is quick to implement and does not require a special finishing step to fill the surface of the plasterboard.

To achieve that, the invention proposes dissociating the guide from the retaining means that holds the guide on the plasterboard.

To this end, one subject of the invention is a guide for cutting a plasterboard and having two longitudinal edges and two ends, in order, in use, to guide a cutting blade in a manner parallel to the guide, characterized in that it comprises, at least at one end, a stop rotatably mounted and provided with retaining means that hold the stop against the plasterboard.

Thus, by virtue of the guide according to the invention, the retention of the guide on the board is on an edge face of the board rather than on a surface face of the board. Further, the securing of the stop to the board is performed before the guide is positioned along the cutting line and allows the guide to be positioned angularly after the stop has been secured to the board.

According to other embodiments:
the stop may comprise two parts connected to one another by an articulation, the two articulated parts being equipped with retaining means for holding the plasterboard, the articulation comprising a rotation end stop;
the rotation end stop may allow a relative rotation of up to 45 degrees, preferably of up to 30 degrees of the articulated parts;
the retaining means may comprise a section piece designed to hold the board when the latter is forcibly inserted into the section piece;
the retaining means may be spikes intended to dig into the plasterboard;
the retaining means may be retractable;
the guide may comprise retaining means arranged on a surface of the guide which surface is intended to be in contact with the plasterboard that is to be cut; these retaining means may be spikes;
the guide may further comprise a rail designed to collaborate, in use, slidingly, with a carriage fitted with the cutting blade;
the guide may comprise, on each side of the rail, flats for contact with the plasterboard that is to be cut;
the guide may further comprise, at least at one of its ends, a retractable stop means in order, in use, to allow the rail to be coupled to and uncoupled from a carriage fitted with the cutting blade;
the guide may comprise, at least at one of its ends, a damping means which, in use, damps the end-of-travel sliding of a carriage fitted with the cutting blade;
the spikes may be arranged in such a way that, in use, once the plasterboard has been cut, the holes formed by the spikes embedded in the plasterboard are situated a determined distance (d) from the cut which is sufficient that the holes can be filled at the same time as a joint between two plasterboards; and/or
the determined distance may be between 75 mm and 150 mm, preferably between 70 mm and 120 mm, advantageously between 55 mm and 80 mm, typically 65 mm.

The invention also relates to a cutting kit, comprising:
a guide according to the invention;
a cutting blade comprising at least one scoring corner having one flat face and one beveled face, the corner being extended by at least one trimming edge having one flat face and one beveled face which are identical to those of the corner;
a cutting carriage comprising a chassis fitted:
   with means intended to collaborate slidingly, in use, with the cutting guide;
   with a handle, mounted such that it can rotate with respect to the chassis and comprising a grip means, a housing for a cutting blade and a retractable engagement dog;
   a section piece provided with at least three notches for blocking the rotation of the handle in three angular positions through reversible engagement of the retractable dog, the notches being arranged on the section piece in such a way that, in use, they allow:
      for the first notch, a retracted arrangement of the blade such that it is not in contact with the plasterboard;
      for the second notch, an arrangement of the blade at an angle a to the plasterboard, in sufficient contact with the plasterboard to score it in order to form a cutting edge face;
      for the third notch, an arrangement of the blade at an angle β to the plasterboard, in sufficient contact with the plasterboard as to trim the cut edge face.

The invention also relates to a method of implementing a guide according to the invention, for cutting a plasterboard, and comprising the following steps:
a) providing a plasterboard comprising a layer of plaster and at least one sheet of cardboard or of paper;
b) positioning the rotably mounted stop against one edge of the plasterboard and activating the retaining means that hold the stop in order to hold the stop against the plasterboard;
c) pivoting the cutting guide to position it along a desired direction of cutting;
d) pressing the guide against the plasterboard; and
e) scoring the board along the guide using a cutting blade.

According to other embodiments:
step d) may consist in driving into the plasterboard spikes which are arranged on a surface of the guide which surface is intended to be in contact with the plasterboard that is to be cut; and/or
step e) may comprise the following steps:
   e1) engaging a carriage bearing the cutting blade with the rail of the guide;
   e2) moving the carriage in order to score the layer of plaster along the guide, from the first edge of the board to the second edge of the board;
   e3) bending the board along the scored line obtained in the previous step in order to snap the layer of plaster along the scored line and obtain a cut edge face;
   e4) using the grip means to move the carriage as far as the first edge of the board;
   e5) moving the carriage in order to trim the cut edge face, from the first edge of the board to the second edge of the board,
   step e2) and/or step e5) involving cutting through at least one sheet of cardboard or of paper of the plasterboard.

Other features of the invention will be set out in the detailed description which follows, given with reference to the attached figures which, respectively, depict:

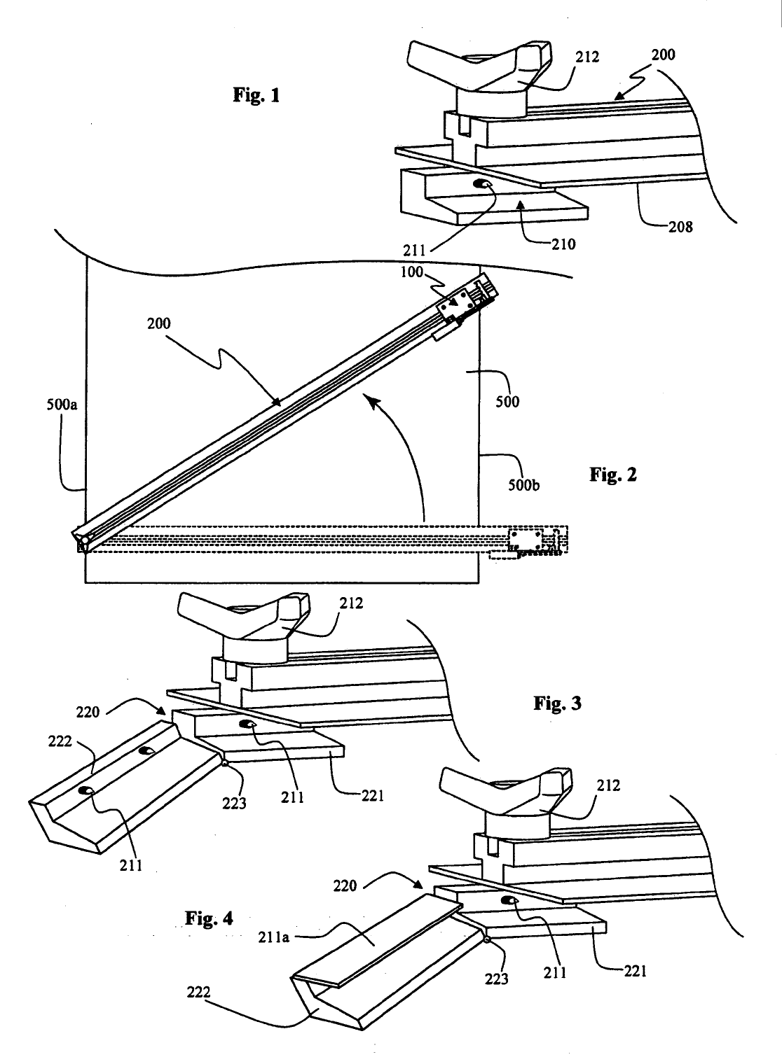

FIGS. 1 and 1a, partial schematic perspective views of two embodiments of one end of a cutting guide according to the invention;

FIG. 2, a schematic plan view of one step in the implementation of a cutting guide according to the invention;

FIGS. 3 and 4, schematic perspective views of two embodiments of one end of a cutting guide according to the invention;

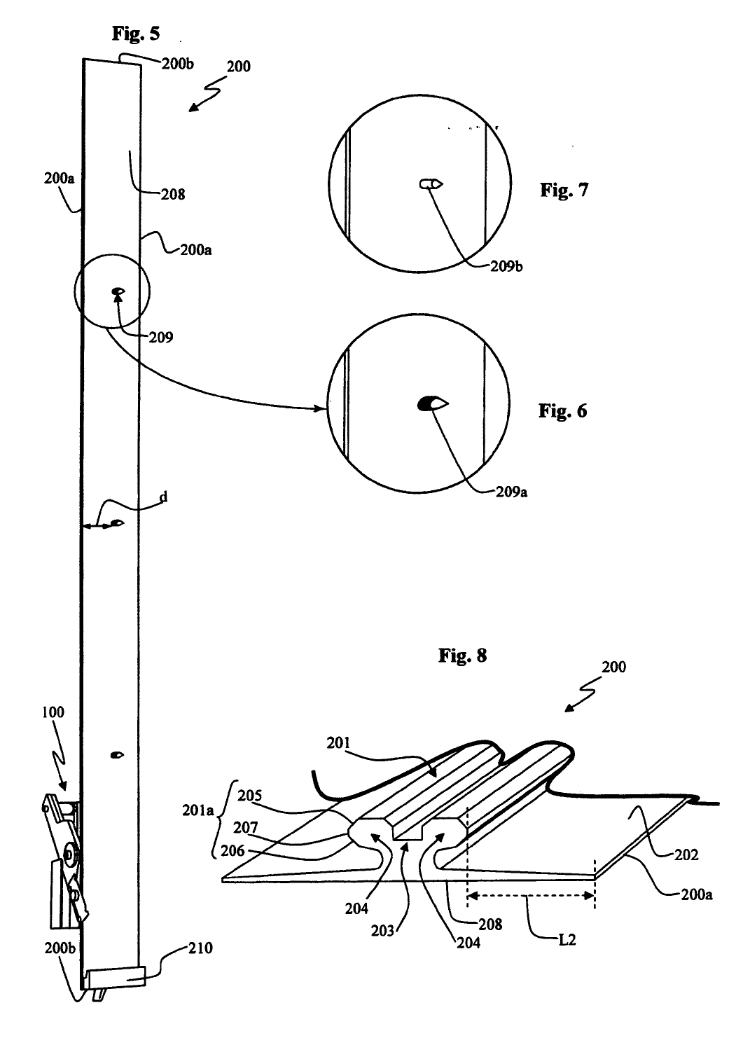

FIG. 5, a schematic perspective view from beneath, in relation to the position of use, of a cutting guide according to the invention;

FIG. 6, a partial perspective enlargement of FIG. 5, showing a first embodiment of retaining means for holding the guide according to the invention on the plasterboard;

FIG. 7, a schematic perspective view of a second embodiment of retaining means for holding the guide according to the invention on the plasterboard;

FIG. 8, a schematic partial perspective view of a cutting guide according to the invention having a rail engaging with a carriage;

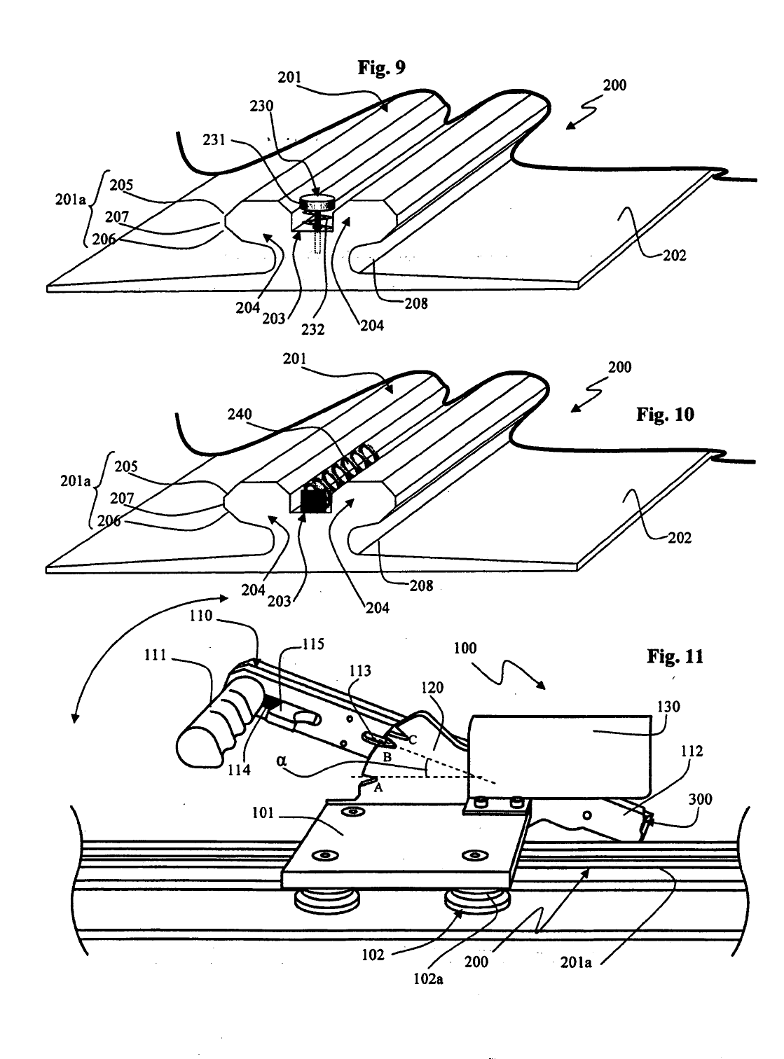

FIG. 9, a schematic partial perspective view of a cutting guide according to the invention having a rail fitted with a retractable stop means;

FIG. 10, a schematic partial perspective view of a cutting guide according to the invention having a rail fitted with a means for damping the end-of-travel sliding of a carriage;

FIG. 11, a schematic left-side perspective view of one embodiment of a carriage according to the invention;

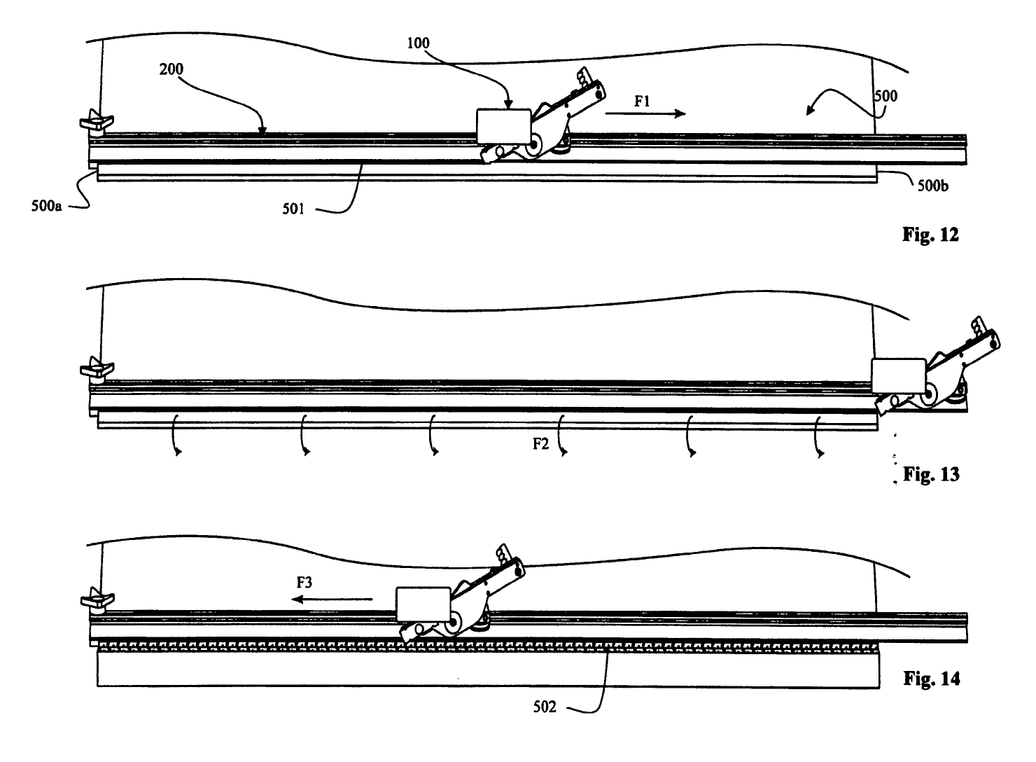

FIGS. 12 to 16, schematic perspective views of a method of implementing cutting using a guide according to the invention;

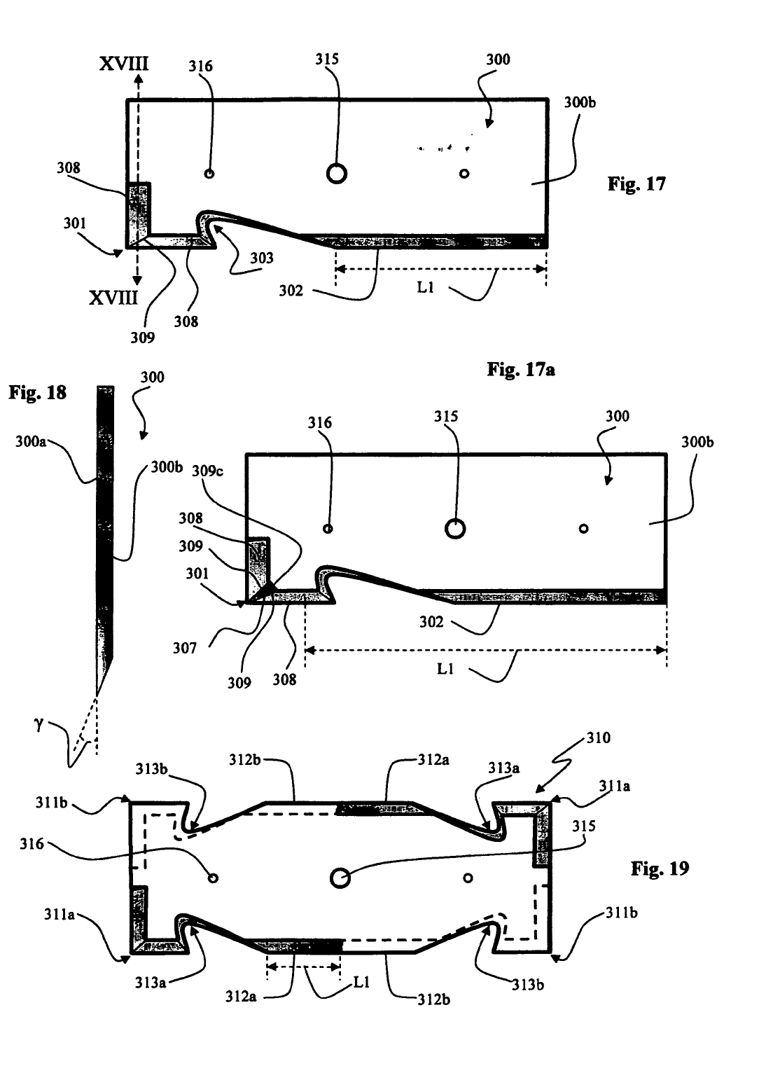

FIG. 17, schematic plan views of a first embodiment of a cutting blade;

FIG. 17a, a schematic plan view of an alternative form of the blade of FIG. 17;

FIG. 18, schematic views in section on XVIII-XVIII of the blade of FIG. 17;

FIG. 19, schematic plan views of a second embodiment of a cutting blade.

A cutting guide according to the invention has two longitudinal edges 200a and two ends 200b. The cutting guide is intended, in use, to guide a cutting blade so that it moves parallel to the guide. According to the invention, the guide comprises, at least at one end 200b, a stop 210 rotatably mounted with respect to the guide and fitted with retaining means 211 that hold the stop against the plasterboard.

In the embodiment illustrated in FIG. 1, this retaining means comprises a spike 211 intended to dig into the thickness of the plasterboard. Thus, the user positions the stop 210 against an edge of the plasterboard and holds this stop against this board by driving the spike 211 into the thickness of the plasterboard. Next, because the stop 210 is rotatably mounted in relation to the guide 200, he can angularly position the guide on the plasterboard at will, as illustrated in FIG. 2.

The retaining means may be retractable. For example, a spike 211 is carried by a screw.

Another embodiment illustrated in figure la is to provide, instead of the spike or spikes (or screw(s)), a blade that is perpendicular to the plasterboard. This blade is preferably triangular so that it penetrates the plasterboard from the underside of the board so that the notch produced will not be visible when the board is fitted.

For preference, the rotary mounting of the stop 210 in relation to the rail 201 can be controlled using a knob 212.

Thanks to the guide according to the invention, retention is not dependent on the firmness of clamping on the surface faces of the plasterboard, but on the edge face. The surface faces of the board are therefore never marked or damaged by this clamping and there is no need, during the finishing operations, to make good the marks present on the edge face because these are not visible during fitting.

Further, retaining means that dig into the plasterboard prevent the stop from slipping sideways during cutting.

Moreover, the time needed to position the guide is reduced in comparison with the known systems. The angular positioning of the guide according to the invention, along the pre-drawn cutting line, is performed after the guide has been attached to the board. This system is therefore quick to implement.

According to one particularly advantageous embodiment, the stop 210 according to the invention comprises two parts joined together by an articulation. This embodiment is illustrated in FIGS. 3 and 4.

In these figures, the stop 220 comprises a part 221 similar to the stop 210 of FIG. 1, and a part 222 connected to the part 221 by an articulation 223. The two articulated parts 221 and 222 are fitted with retaining means 211 for holding the plasterboard. In FIG. 3, the retaining means of the articulated part 222 comprise spikes 211. In FIG. 4, these retaining means comprise a plate 211a designed to allow the plasterboard to be held forcibly between this plate 211a and a protrusion 211b of the articulated part 222. This arrangement can be obtained by making the articulated part 222 as a single profiled structure.

The stop 210 advantageously comprises a rotation end stop allowing limited rotation of the articulated parts 221 and 222. In practice, the rotation end stop advantageously limits the rotation to between 0 and 45 degrees and preferably between 0 and 30 degrees.

Thanks to these articulated parts, to the plasterboard retaining means and to the rotation end stop, the user can cut a large-sized plasterboard all by himself without the risk of the offcut 504 (see FIGS. 17 and 18) falling during cutting, and thus tearing the lower sheet of paper and/or breaking.

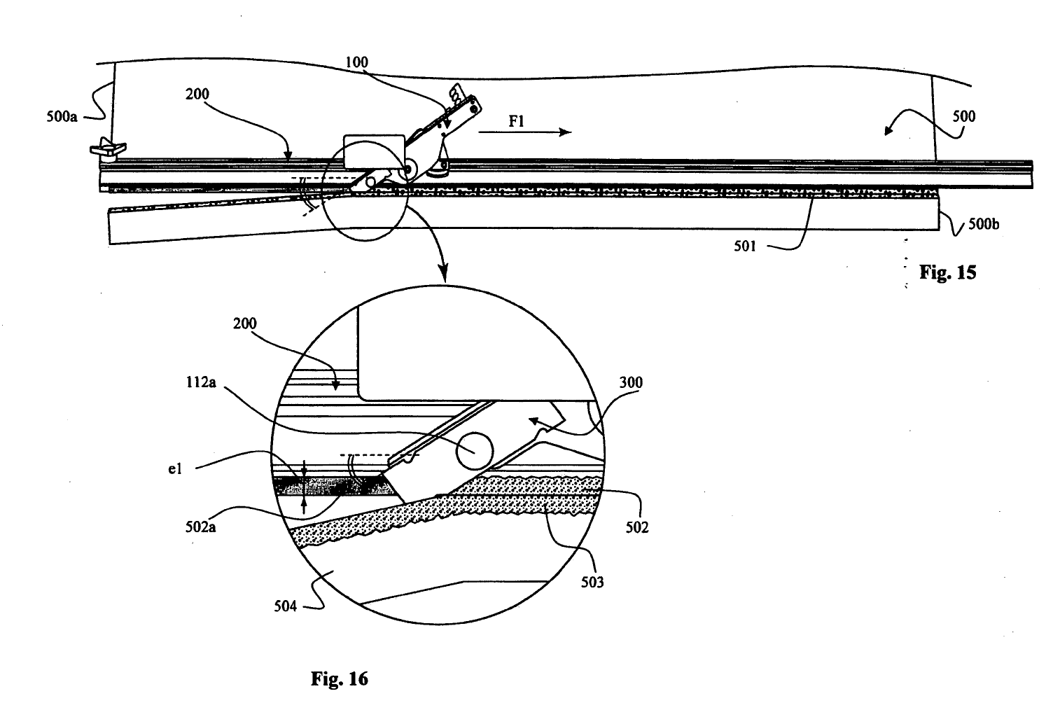

Specifically, as the user snaps the board along the scored line (see FIG. 15) and begins to trim the cut edge face (see FIGS. 17 and 18), the already-separated end of the offcut 504 is held by the articulated part 222.

For preference, the cutting guide according to the invention may have retaining means arranged on the surface face 208 that is intended to be in contact with the plasterboard. As illustrated in FIGS. 5 to 7, these retaining means may comprise spikes intended to dig into the plaster of the plasterboard.

Thus, when the user has positioned the guide as desired, all he has to do is lean on this guide and the spikes of the retaining means will dig into the board and prevent the guide from shifting from its position of use during the various cutting steps (see FIGS. 14 to 18).

In the embodiment of FIG. 7, the spikes are carried by rods 209b.

Advantageously, the retaining means are retractable so that when the guide is not in use the spikes will not injure the user. In the embodiment of FIGS. 5 and 6, these spikes are carried by screws 209a. When the user wishes to use the guide, he uses a screwdriver to cause the screws to protrude from the plane of the surface 208. When the user has finished cutting, he unscrews the screws until they leave the plane of the surface 208.

Any other means of rendering the spikes retractable can be used in the guide according to the invention.

In these embodiments (retractable or non-retractable spikes), the board is said to be “self-securing” because simply pressing it against the plasterboard is enough to immobilize it in the cutting position. In that case, the user has no further action to perform in order to immobilize the guide.

For preference, the retaining means 209 are arranged on the surface face 208 of the guide so that, in use, once the plasterboard has been cut, the holes formed by the spikes embedded in the plasterboard are situated at a determined distance d from the cut, which is sufficient that the holes can be filled at the same time as a joint between two plasterboards.

For example, the retaining means 209 are positioned at the distance d from the edge 200a of the guide.

Conventionally, the finishing operations are performed using a plastering knife of between 150 mm and 300 mm wide.

Thus, the spikes of the retaining means will preferably be arranged at a determined distance of between 75 mm and 150 mm, preferably between 70 mm and 120 mm, advantageously between 55 mm and 80 mm and typically 65 mm.

The holes formed by the spikes are arranged in a region particularly close to the cut edge face, so that the finishing operation does not need to include a specific step to fill these holes, independent of the filling of the space between two consecutive boards.

The retaining means carried by that face of the guide that is intended to come into contact with the plasterboard may also consist of a groove in which a gripper or clamping stop is slidably mounted. As soon as the user has positioned the guide, all he needs to do is slide the gripper or clamping piece along the groove and forcibly press it against the plasterboard in order to immobilize the guide in the position of use.

The retaining means carried by that face of the guide that is intended to be in contact with the plasterboard may also consist of a pair of magnets. One of the magnets being positioned in a groove carried by said face of the guide. This magnet may be continuous, all along the length of the groove, or consist of a multitude of individual magnets arranged, preferably evenly, in the groove along the length of the guide.

As soon as the user has positioned the guide, all he needs to do is position a second magnet under the sheet, opposite the guide and the first magnet, thus immobilizing the guide in the cutting position.

In the latter two embodiments (gripper or stop and pair of magnets) the guide is not really self-securing because the user has to activate these retaining means after having positioned the guide. Nonetheless, such a guide is far easier to position and to keep in position than the current solution of positioning the guide and then of positioning two clamps at the ends of the guide. The cutting guide according to the invention advantageously comprises means of engaging slidably with a cutting carriage. For this purpose, the cutting guide comprises a profiled rail like the one illustrated in FIG. 8.

In one particularly advantageous embodiment, the guide 200 has a profiled rail 201 intended to engage with the rollers 102 of a carriage (see FIG. 11), this rail 201 being extended laterally by flats 202 that increase the area of contact between the guide and the plasterboard and the stability of the guide on the board.

The rail 201 may adopt all kinds of shapes. One particularly advantageous shape, illustrated in FIG. 8, gives the carriage according to the invention greater stability and better retention. Around a longitudinal groove 203, the rail 201 comprises two longitudinal protrusions 204. Each of these protrusions has a part 201a intended to engage slidably with the rollers 102 of the carriage 100. Each part 201a comprises non-coplanar straight faces 205-206 connected by a flat 207 substantially perpendicular to the contact face 208 via which the guide 200 is in contact with the plasterboard.

Retaining screws 209a are preferably inserted in the longitudinal groove 203. Advantageously, these screws 209a are of a length such that, when not screwed in, they are held in the groove 203 and prevent the carriage from engaging with the rail.

The flats 202 preferably have a width L2 that is tailored so that, in use, the cutting blade 300 is in tangential contact with the longitudinal edge 200a of one of the flats 202.

Through that contrivance, the user can easily position the guide because all he has to do is make the edge of the flat coincide with the marked-out line of the cut previously drawn by the user. Further, contact between the flat 202 and the blade prevents the blade from oscillating under the action of the movement of the carriage.

According to another embodiment illustrated in FIG. 9, the rail of the guide may comprise a retractable stop means 230 to allow the rail to be coupled to and uncoupled from the carriage, in use. Thus, when the carriage is coupled to the rail, the retractable stop means prevents the carriage from leaving the rail as it moves. After use, for ease of transport, it is desirable to uncouple the carriage from the rail. The user therefore deactivates the retractable stop means and removes the carriage from the rail. For example, by way of retractable stop means it is possible to use a pin 231 fitted with a return means 232.

According to another embodiment illustrated in FIG. 10, it is also possible, as an alternative or in combination, to fit at least one of the ends of the rail with a damping means 240 which, in use, damps the end-of-travel sliding of the carriage. Thus, the carriage cannot violently strike the retractable stop means or the carriage cannot violently leave the rail. For example, it is possible to use a spring or a piston as damping means.

FIG. 11 illustrates one embodiment of a carriage for cutting a plasterboard that can be used with a guide according to the invention. The carriage 100 comprises a chassis 101 fitted with means of slidable engagement with a cutting guide 200. The engagement means are, in this embodiment, rollers 102 equipped with a groove 102a intended to accept a part 201a of a rail 201 borne by the guide 200.

The rollers 102 allow the chassis 101 to be slid along the rail 201.

The chassis 101 comprises a handle 110 mounted such that it can rotate in relation to the chassis 101. The handle comprises a grip means 111 consisting, in this embodiment, of a profiled handgrip.

The handle also comprises a housing 112 for a cutting blade 300.

The chassis 101 also comprises a section piece 120 provided with three notches A, B and C. These notches are intended to block the rotation of the handle 110 thanks to the engagement of a retractable dog 113 borne by the handle. Advantageously, the retractable engagement dog is coupled to a trigger 115 connected to a tension spring 114 that presses the dog towards the blind end of the notches.

In this way, the user holding the handle 110 via the handgrip 111 can retract the dog 113 from the notch in which it is engaged (in this instance notch B) by pulling the trigger 115 back against the action of the tension spring 114 using one of his fingers of the hand resting on the handgrip 111. He can then pivot the handle 110 with respect to the chassis 101 until the dog 113 engages in another notch A or C.

Thanks to the section piece 120 and to the notches A, B and C, the handle can be positioned in a preset manner in three angular positions through the reversible engagement of the retractable dog 113 in the notches.

These notches are arranged on the section piece in such a way as to allow, in use:
for the first notch A, an arrangement of the blade 112 such that it is not in contact with the plasterboard;
for the second notch B, an arrangement of the blade at an angle a to a plasterboard, in sufficient contact with this plasterboard to score it in order to form a cut edge face (see FIGS. 15 and 16);
for the third notch C, an arrangement of the blade 300 at an angle β to the plasterboard, in sufficient contact with this plasterboard as to trim the cut edge face (see FIGS. 18 and 19) and cut through any sheet of paper or of cardboard borne by the lower surface face of the board (the lower surface face being the opposite surface face to the one bearing the guide 200 and/or the carriage 100).

For preference, the carriage 100 further comprises a protective casing 130 for protecting the blade 300 when the dog 113 is engaged in the first notch A. In this position, the blade is not in contact with the plasterboard. This position advantageously constitutes a safe transport position in which the blade is inaccessible to the user who cannot therefore injure himself on the blade.

Thanks to the notched section piece 120, the angular positions of the handle are predetermined and preset. Thus, the user does not need to pay attention to the angle of the blade in relation to the plasterboard. All he has to do is to move from one notch to another in order to obtain the various blade positions. His only concern is to move the guide in relation to the board.

FIGS. 12 to 16 illustrate how the abovementioned carriage according to the invention works.

On a plasterboard 500, a cutting guide 200 is positioned along the direction of cutting desired by the user. Before or after this positioning, the user causes the carriage 100 to engage slidably with the cutting guide 200.

Once the guide is in position, the user places the carriage at a first edge 500a of the board 500. In FIG. 12, the first edge is situated to the left; this arrangement is suitable for use by a right-handed user. This first edge is the edge at the blade end of the carriage and the opposite end to the handgrip of the grip means. Next, the user operates the retractable engagement dog to remove it from notch A, from the transport position, and pivot the handle until the dog engages in the second notch B, so that the blade is in sufficient contact with the board to score it. The user then moves the carriage in the direction of the arrow F1, by pulling the carriage from the first edge 500a of the board 500 to the second edge 500b of the board 500. During this movement, in the direction of the arrow F1, the blade scores 501 the layer of plaster of the board 500. If this layer of plaster is covered by a sheet of paper or of cardboard, the blade cuts through this sheet at the same time as scoring the plaster.

During this movement, the only concern of the user is to pull the carriage between the two edges of the board in order to score and cut this board. He does not need to concern himself with the position of the blade or the inclination thereof. Thanks to notch B of the carriage, the scored line is perfectly even both in terms of its shape along the board and in terms of its depth.

Once he has reached the second edge 500b of the board, the user bends the board along the scored line obtained in the previous step in order to snap the layer of plaster along the scored line. This bending in the direction of the arrows F2 (see FIG. 13) yields a cut edge face 502 illustrated in FIG. 14. Thanks to the perfect straightness of the scored line, the cut edge face obtained is far more even than the cut edge faces obtained using the cutting method employing a cutter.

In order further to improve the flatness of this cut edge face, the carriage according to the invention offers a handle, and, therefore, blade, position that allows the cut edge face 502 to be trimmed. For that, as illustrated in FIG. 14, the user moves the carriage using the grip means from the second edge of the board to the first edge of the board in the direction of the arrow F3, then actuates the retractable engagement dog to withdraw it from the second notch B and pivots the handle until the dog engages in the third notch C. In this position, the blade presents a trimming edge that is pressed against the cut edge face obtained in the board bending step. The user moves the carriage once again from the first edge 500a to the second edge 500b so that the cut edge face is trimmed by the blade. This step is illustrated in FIGS. 15 and 16. The latter FIG. 16 shows the untrimmed cut edge face 502 in the right of the figure and a trimmed cut edge face 502a in the left of the figure. Of course, the cut edge face 503 of the offcut 504 of the board 500 is not trimmed during this step.

At the same time as the blade is trimming the cut edge face, it is also, where one is present, cutting through the sheet of paper or of cardboard on the underside surface face of the plasterboard.

During this movement, the user does not have to concern himself with the position of the blade which is preset by the arrangement of the notch C. This angular position of the third notch C is dependent on the thickness of the plasterboard. In the example illustrated, the third notch C is spaced away from the second notch B to allow the trimming of a cut edge face of a plasterboard of thickness e1 (see FIG. 16).

Advantageously, the carriage may comprise at least one additional notch (for example notches D and E) separated from the third notch C to allow the trimming of a cut edge face of a plasterboard of thickness e2 or e3 different than the thickness e1 that can be trimmed when the trigger is engaged in notch C. A person skilled in the art will be able to provide as many notches as required, depending on the number of thicknesses of board that the carriage according to the invention is intended to cut. For example, notch C could make it possible to trim the edge face of a plasterboard 10 mm thick, a notch D could allow the trimming of the edge face of a board 13 mm thick (conventionally known in France as a “BA13 board”), and a notch E could make it possible to trim the cut edge face of a board 15 mm thick. Other notches could be provided for other thicknesses.

The use of a guide according to the invention, as described hereinabove, is particularly effective when a blade according to FIGS. 17 to 19 is employed.

Unlike a cutter blade comprising a cutting edge that is beveled on both sides, the cutting blade 300 comprises at least one scoring corner 301 which, in cross section, has one flat face 300a and one beveled face 300b (see FIG. 18). The corner is thus defined by, on one side, a flat face and, on the other side, a beveled face having two beveled edges 308. The two beveled edges 308 are connected by at least one connecting line 309.

This special shape of the cutting edge of the blade ensures perfectly straight scoring by preventing the blade from oscillating during scoring, unlike the phenomena observed using a cutter blade.

If the blade employed is a blade according to the one depicted in FIGS. 12 to 14, then it is the flat face of the blade that is preferably pressed against the edge 200a of the flat 202, rather than the beveled face. That improves the guidance of the blade by optimizing the area of contact between the blade and the guide.

The beveled face cuts though the first sheet of cardboard and scores the layer of plaster, and the flat face keeps the blade in the same position during the scoring of the plaster. The inventor has discovered that it is this ability to keep the blade positioned perpendicular to the plasterboard that makes it possible to obtain a perfectly straight scored line and a cut edge face that is far more uniform than when cutter blades are used. Because cutter blades are beveled on both sides, it is very difficult, if not to say impossible, even when using a guide, to keep the blade in position which means that these cutter blades hunt and the cut edge face obtained as a result is very uneven.

The best results have been obtained with an angle γ between the flat face and the beveled face of between 15 and 25 degrees, and preferably with an angle γ of 20 degrees. Thus, when the bevel is at such an angle, the blade remains perfectly straight and does not oscillate during scoring. Further, the scoring obtained is of a depth and shape such that when the user bends the plasterboard (as in FIG. 8), the edge face obtained is far more even than that obtained with a cutter blade.

In order further to improve the uniformity and flatness of the cut edge face, the blade further comprises a trimming edge 302 which likewise has one flat face and one beveled face. The trimming edge 302 is of a length L1 greater than or equal to the thickness of the plasterboard. If this thickness is denoted e, then the length L1 of the trimming edge needs to be greater than or equal to: e/sine β, β being the angle between the blade and the plasterboard when the trigger is engaged in the third notch C of the carriage (see FIGS. 15 and 16). Of course, when the carriage comprises more than three notches, the length L1 of the trimming edge needs to be greater than or equal to the thickness of the plasterboard divided by the sine of the smallest β angle of these notches.

In one particularly advantageous embodiment, the blade comprises, between the scoring corner 301 and the trimming edge 302, a cutting notch 303. This notch is useful when the plasterboard comprises a sheet of paper or of cardboard on the underside surface face of the plasterboard, when the plasterboard is in the cutting position. Thus, during the step of trimming the cut edge face, this sheet of paper or of cardboard is engaged in the notch 303 which allows this sheet to be cut cleanly and sharply and prevents this sheet from simply been torn. Advantageously, to make this cutting easier, the cutting notch is curved.

Combining the trimming of the cut edge face with the cutting of the bottom sheet of paper makes it possible to obtain a cut plasterboard none of the sheets of paper of which is torn and the cut edge face of which has no protrusion and is perfectly parallel to the guide of the carriage used (and therefore perfectly straight if the guide is a straight rule).

The juxtaposition of several plasterboards is therefore optimized, and the amount of filler materials used for finishing is greatly limited. Further, the fact that the sheets of paper or of cardboard are not torn means that surface unevenesses of the plasterboard do not need to be filled.

The blade has a hole 315 intended to engage with a bolt fitted with a nut 112a arranged in the blade housing 112 of the carriage 100. The blade 310 also has holes 316 intended to engage with fixed rods arranged in the housing 112 to retain the blade and prevent it from pivoting about the bolt 112a. Of course, any other means of securing the blade in the housing can be used, provided that this means of attachment holds the blade firmly so that it is perpendicular to the plasterboard.

Thus, with a blade according to the invention, the flat face 300a of the blade 300 is kept perpendicular to the plasterboard during the scoring and the trimming.

FIG. 17a illustrates an alternative form of the blade of FIG. 17.

In this alternative form, the scoring corner 301 has a connecting facet 307 connecting the two beveled edges 308 of the scoring corner.

The connecting facet 307 is delimited by two connecting lines 309, and by a connecting line 309c connecting it to the beveled face 300b. The connecting facet 307-317a-317b forms a plane that makes an angle δ with the flat face 300a. The angle δ is less than the angle γ that the beveled edges 308 make with the flat face 300a. Advantageously, the angle δ is between 10 and 20, and preferably an angle δ of 15 degrees. The preferred embodiment is an angle γ of 20 degrees and an angle δ of 15 degrees.

The connecting face 307-317a-317b makes it easier for the blade to penetrate the sheet of plaster during scoring and limits loading during manipulation. Further, the inventor has discovered that the loading applied to the offcut in order to snap the sheet of plaster is also limited.

Specifically, the connecting face 307 very appreciably improves the scoring achieved during the scoring step (see FIG. 12). When there is no connecting face, the single connecting line 309 can rub firmly against the plaster and pull out small pieces of plaster and paper or cardboard during the scoring operation. The scored line may then sometimes, particularly when scoring is performed very quickly, exhibit abrasions which, when the board is bent (see FIG. 13) give rise to a somewhat uneven cut edge face. The connecting face 307 limits friction between the scoring corner and the board so that the scored line obtained is particularly even. It has practically no abrasions. The cut edge face obtained is very even and exhibits only very few protrusions, those being small-sized protrusions. The subsequent trimming step is therefore easier and constitutes nothing more than a finishing operation in order to obtain a cut edge face that is perfectly flat, with no protrusions that could impede the positioning of two boards one against the other.

This alternative form can be applied to the embodiment illustrated in FIG. 19.

In general, on a worksite, it is necessary to make numerous cuts in plasterboards. All these cuts wear the blade which means that, during the cutting movements, (see FIGS. 12 to 16), the blade may become blunt. Scoring is therefore no longer straight and, when the user bends the cardboard (see FIG. 13), the cut edge face is sometimes no longer perfectly parallel to the guide and may be highly uneven (with numerous protrusions). It then becomes necessary to change the blade.

One particularly advantageous blade embodiment is illustrated in FIG. 19. In this embodiment, all four corners of the plate that make up the blade are used as scoring corners. Each of these corners is extended by a trimming edge. Between each corner and the trimming edge, the blade has a cutting notch. In this embodiment, two diametrically opposed scoring corners 311a-311a are symmetric about the center of the rectangular plate of which the blade 310 is made. By contrast, two consecutive scoring corners 311a-311b have opposite flat and beveled faces. What that means, as FIG. 19 illustrates, is that one scoring corner 311a has a beveled top face and a flat bottom face whereas one scoring corner 311b has a flat top face and a beveled bottom face. The same is true of the other structures that are the trimming edges 312a and 312b and the cutting notches 313a and 313b.

The embodiment of FIG. 19 allows the two scoring corners 311a to be used by pivoting the blade about the hole 315 and allows the two scoring corners 311b to be used by turning the blade over. Thus, using one and the same blade 310, four scoring and trimming zones are available that can be used in succession once one of these zones becomes worn out.

In alternative embodiments that have not been illustrated, the blade may have just one, just two or just three zones each comprising a scoring corner, a trimming edge and a cutting notch.

In another embodiment that has not been illustrated, the blade is suited both to left-handed users and to right-handed users.

Such a blade for example has four scoring corners, four trimming edges and four cutting notches. In this embodiment, two diametrically opposed scoring corners are symmetric about the center of the rectangular plate and two consecutive scoring corners have the same face flat and the same face beveled. With this embodiment, it is possible to produce a blade that can be used either from left to right or from right to left.

To do this, provision may be made for the cutting carriage according to the invention to be removable and configurable either for a right-handed user or for a left-handed user. Thus, the section piece bearing the notches and the handle may be fixed on each of the two sides of the chassis. Where there is a protective cover, provision is also made for this cover to be removable and attachable either to suit a right-handed user or to suit a left-handed user. FIG. 11 illustrates an arrangement suitable for use by a right-handed user.

Of course, it is possible to provide just one cutting zone for a right-handed user and just one cutting zone for a left-handed user.

1. A guide for cutting a plasterboard and having two longitudinal edges and two ends, in order, in use, to guide a cutting blade in a manner parallel to the guide, comprising, at least at one end, a stop rotatably mounted and provided with retaining means that hold the stop against the plasterboard, characterized in that it comprises retaining means arranged on a surface of the guide which surface is intended to be in contact with the plasterboard that is to be cut.

2. The guide as claimed in claim 1, in which the retaining means are spikes.

3. The guide as claimed in claim 1, in which the stop comprises two parts connected to one another by an articulation, the two articulated parts being equipped with retaining means for holding the plasterboard, the articulation comprising a rotation end stop.

4. The guide as claimed in claim 3, in which the rotation end stop allows a relative rotation of up to 45 degrees, preferably of up to 30 degrees of the articulated parts.

5. The guide as claimed in claim 1, in which the retaining means comprise a section piece designed to hold the board when the latter is forcibly inserted into the section piece.

6. The guide as claimed in claim 1, in which the retaining means are spikes intended to dig into the plasterboard.

7. The guide as claimed in claim 6, in which the retaining means are retractable.

8. The guide as claimed in claim 1, further comprising a rail designed to collaborate, in use, slidingly, with a carriage fitted with the cutting blade.

9. The guide as claimed in claim 8, comprising, on each side of the rail, flats for contact with the plasterboard that is to be cut.

10. The guide as claimed in claim 8, further comprising, at least at one of its ends, a retractable stop means in order, in use, to allow the rail to be coupled to and uncoupled from a carriage fitted with the cutting blade.

11. The guide as claimed in claim 8, comprising, at least at one of its ends, a damping means which, in use, damps the end-of-travel sliding of a carriage fitted with the cutting blade.

12. The guide as claimed in claim 7, in which the spikes are arranged in such a way that, in use, once the plasterboard has been cut, the holes formed by the spikes embedded in the plasterboard are situated a determined distance (d) from the cut which is sufficient that the holes can be filled at the same time as a joint between two plasterboards.

13. The guide as claimed in claim 12, in which the determined distance (d) is between 75 mm and 150 mm, preferably between 70 mm and 120 mm, advantageously between 55 mm and 80 mm, typically 65 mm.

14. A kit for cutting a plaster board, comprising:
a guide as claimed in claim 8;
a cutting blade comprising at least one scoring corner having one flat face and one beveled face, the corner being extended by at least one trimming edge having one flat face and one beveled face which are identical to those of the corner;
a cutting carriage comprising a chassis fitted:
with means intended to collaborate slidingly, in use, with the cutting guide;
with a handle, mounted such that it can rotate with respect to the chassis and comprising a grip means, a retractable engagement dog and a housing for a cutting blade;
a section piece provided with at least three notches for blocking the rotation of the handle in three angular positions through reversible engagement of the retractable dog, the notches being arranged on the section piece in such a way that, in use, they allow:
for the first notch, a retracted arrangement of the blade such that it is not in contact with the plasterboard;
for the second notch, an arrangement of the blade at an angle a to the plasterboard, in sufficient contact with the plasterboard to score it in order to form a cut edge face;
for the third notch, an arrangement of the blade at an angle β to the plasterboard, in sufficient contact with the plasterboard as to trim the cut edge face.

15. A method of implementing a guide as claimed in claim 1, for cutting a plasterboard, characterized in that it comprises the following steps:
a) providing a plasterboard comprising a layer of plaster and at least one sheet of cardboard or of paper;
b) positioning the rotably mounted stop against one edge of the plasterboard and activating the retaining means that hold the stop in order to hold the stop against the plasterboard;
c) pivoting the cutting guide to position it along a desired direction of cutting;
d) pressing the guide against the plasterboard; and
e) scoring the board along the guide using a cutting blade.

16. The method of implementation as claimed in claim 15, in which step d) consists in driving into the plasterboard spikes which are arranged on a surface of the guide which surface is intended to be in contact with the plasterboard that is to be cut.

17. The method as claimed in claim 15 wherein said guide further comprises a rail designed to collaborate, in use, slidingly, with a carriage fitted with the cutting blade, in which step e) comprises the following steps:
e1) engaging a carriage bearing the cutting blade with the rail of the guide;
e2) moving the carriage in order to score the layer of plaster along the guide, from the first edge of the board to the second edge of the board;
e3) bending the board along the scored line obtained in the previous step in order to snap the layer of plaster along the scored line and obtain a cut edge face;
e4) using the grip means to move the carriage as far as the first edge of the board;
e5) moving the carriage in order to trim the cut edge face, from the first edge of the board to the second edge of the board,
step e2) and/or step e5) involving cutting through at least one sheet of cardboard or of paper of the plasterboard.
